(19) United States
(12) Patent Application Publication
(10) Pub. No.: US 2007/0119531 A1
(43) Pub. Date: May 31, 2007

(54) Airless spare tire

(75) Inventors: Richard A. Steinke, Boulder City, NV (US); Theodore M. Love, Las Vegas, NV (US); James G. Moore, Boulder City, NV (US)

Correspondence Address: M. REID RUSSELL, 854 WEST 3390 SOUTH, HURRICANE, UT, 84737, US

(73) Assignee: Amerityre

(21) Appl. No.: 11/286,424

(22) Filed: Nov. 25, 2005

(51) Int. Cl. B60C 7/00

(52) U.S. Cl. 152/324

(57) ABSTRACT

An airless spare tire formed from an elastomeric material, preferably a polyurethane material, that includes an outer tread, like side walls and a closed undersurface, and where the side walls have identical spaced cavities formed therein, each to intersect a center section, and which cavities each have the shape of a parallelogram with rounded corners, and have one long side at a selected angle to a tire radius from the tire center, with their short sides essentially parallel to the tire tread. Which cavities on one side of the tire are offset to those on the other tire side and the angle of the parallelogram shaped cavity long side to a radial is selected to provide for an alignment of side wall sections on one tire side with end or centers of the side wall sections on the other tire side.

### BACKGROUND OF INVENTION

1. Field of The Invention

This invention pertains to tires formed from an elastomeric material by spin casting, vacuum forming, or other casting process, providing a solid tire suitable for limited use as a vehicle spare tire.

2. Prior Art

The present invention is in an airless spare tire that is formed from an elastomeric material, preferably a polyurethane. The tire, formed from a urethane material, is for mounting to a rim, and the tire and rim wheel combination are maintained within or without a vehicle until needed as when one of the vehicle's pneumatic tires deflates. Very early tires and spare tires were formed as solid rings from an elastomeric material and some examples of such are shown in earlier U.S. patents to Divine, U.S. Pat. No. 1,056,975; to Henderson, U.S. Pat. No. 1,194,177; and to Hitchner, U.S. Pat. No. 1,670,721, that illustrate very early uses of solid elastomeric tires on buggies and early automobiles. Such solid tires, of course, were not capable of carrying a significant load at high speeds, or for carrying a load at highway speeds.

For many years, a fifth spare tire that was essentially a same tire as those mounted on an automobile or truck, has been included with the purchase of that vehicle. Such spare tire, as it is located in the trunk, or under the vehicle, is often ignored and over time goes flat before it is needed. Today, a number of run flat tires have been developed as alternatives to a spare tire and examples of such as shown in U.S. patents to Ryder, U.S. Pat. No. 3,814,158; to Sarkissian, U.S. Pat. No. 4,246,948; to Forte, U.S. Pat. No. 5,341,861; and to Steinke, et al, one of the inventors of the present invention, U.S. Pat. No. 6,679,306. In addition to which run flat tires, some companies have produced solid elastomeric tires manufactured onto or mounted to a wheel, that will provide limited service in the event of a tire deflation. Such tires are shown as the products of manufacturing processes set out in a U.S. patent to, Steinke, et al., U.S. Pat. No. 5,906,836, with Steinke as a co-inventor of this and the present invention. Further, solid tires and wheels are shown in U.S. patents to Gunn, U.S. Pat. No. 3,331,423; to Alderfer, U.S. Pat. No. 3,396,773; to Britz, U.S. Pat. No. 4,909,972 and to Becker, U.S. Pat. No. 5,229,047. The present invention, while like the product produced in the apparatus of U.S. Patent to Steinke, et al., U.S. Pat. No. 5,906,836, in that it is a tire formed by casting methods from a closed cell elastomeric material, preferably a urethane material, it's design is unlike such tire and any of the other tires shown in the cited prior art. Specifically, where earlier foam tires have had a usual tire shape to provide for load transfer around and through the tire into the wheel rim, the invention utilizes a unique side wall structure where the tire opposite side walls are formed with spaced parallelogram cavities around the tire side wall mid-section, with the parallelogram spaced cavities tilted oppositely on the opposite tire sides, and provide for an offset alignment between cavities. Which side wall cavity arrangement provides for a columnar transfer of loads introduced into the tire tread, and substantially reduces the tire mass, thereby reducing tire heating under load as occurs in a solid elastomeric tire.

### SUMMARY OF THE INVENTION

It is a principal object of the present invention is to provide an airless spare tire manufactured from an elastomeric material having like equal spaced cavities formed in and around the tire side walls, which cavities are parallelograms, with each pair of cavities separated by a tire center section, with the cavities around one tire side slightly offset to the cavities of the other side, and the cavities on the opposite tire sides are sloped oppositely to provide for alignment of a section of a tire side wall adjacent to a cavity with the top or mid section of the tire side wall section on the other tire side.

Another object of the present invention is to provide a spare tire formed from a polyurethane material by casting or molding methods with the tire having equal spaced cavities formed in the tire side walls, which set of cavities on one tire side wall are slightly off-set from the cavities on the other tire side wall and are separated by a center divider section, and with the cavities formed as identical parallelograms, with rounded comers, and are arranged in pairs across the tire with side wall sections between adjacent cavities align with ends or mid sections of the cavities across the center divider, whereby the tire side wall material between the offset cavities will function as trusses, transferring compressive loads across the tire side walls.

Another object of the present invention is to provide a cast or molded spare tire where a plurality of equal spaced cavities are formed around both tire side walls that have like parallelogram shapes, with rounded comers, and where the cavities that are across and slightly off set from one another on the opposite tire side walls to where the opposing tire side wall sections between the cavity align with one another across the center divider to align the tire side wall sections with the mid sections of one another or to align ends thereof.

Still another object of the present invention is to provide a spare tire formed from an elastomeric material to have less weight than earlier elastomeric tires of comparable in size, will support a load that is comparable to or greater than a load supported by such earlier elastomeric tires and will run cooler and even greater loads and longer distances than will such earlier elastomeric tires.

Still another object of the present invention is to provide a is an elastomeric tire that is simple to form by molding or casting methods in a single operation and will provide a unique tire design with equal spaced cavities formed in both side walls, providing a tire that is of lesser weight than a comparable size of a solid elastomeric tire and will run longer and support a greater load at greater speeds than such comparable size of solid elastomeric tire.

The present invention is in an airless spare tire formed from an elastomeric material, preferably a polyurethane material, by molding or casting methods. The tire includes a top or outer tread area, has an open center area arranged for mounting onto a wheel, or may be cast onto a wheel during its formation. Center sections around both the tire side walls include a plurality of like equally spaced apart cavities, formed as parallelograms with rounded comers. The cavities are equidistant from the tire center and each is spaced apart an equal distance from adjacent cavities, leaving wall sections between the parallelogram longest sides. Which cavities are of a uniform depth and extend to, and are spaced apart by, a tire center dividing wall. The set of cavities around one tire side are slightly offset from the cavities on the other side wall, and are separated by the tire center diving wall, whereby the wall sections of a cavity on the one side will align with to appear to cross the opposite wall section. So arranged, the off set side wall sections are connected by the center dividing wall and tend to function as trusses, providing, depending upon slope of the parallelogram longest side to a radial across the tire side wall, an X truss to a V truss, for transferring compressive loads exerted through the tire tread, across the tire wall sections and into the tire mounting to a wheel. A load bearing capability is thereby provided to the tire of the invention that is at least as strong as is provided by a like size of a solid elastomeric tire and at a significantly lesser tire weight. Which cavities and adjacent side walls sections will also provide flexure to the tire during travel under load, to essentially mimic the ride provided by a pneumatic tire.

Additionally, in practice, a solid standard tire that is subjected to normal vehicle loads and highway speeds will experience a heat buildup in the tire interior due to tire flexure. Over time, unless the heat is dissipated out of the tire, the tire material will separate, destroying the tire. Whereas, with the tire of the invention, the cavities function as radiators, dissipating heat, and maintaining the tire temperature below where damage could occur.

### DESCRIPTION OF THE DRAWINGS

The invention may take physical form in certain parts and arrangement of parts, used to form the tire of the invention that are herein shown as a preferred embodiments and will be described in detail in this specification and illustrated in the accompanying drawings which form a part hereof:

FIG. 1 shows a side elevation perspective view of a spare tire of the invention;

FIG. 2 shows a front elevation view of the spare tire of FIG. 1, showing spaced parallelogram cavities formed in one tire side wall, it being understood that, when view from the opposite tire side, the cavities are identical to those shown in FIG. 2;

FIG. 3 shows an enlarged front sectional view taken within the line 3-3 of FIG. 2, showing in broken lines, parallelogram shaped cavities formed in the opposite tire side wall, with the side wall sections between which cavities shown as offset to appear to cross at their ends;

FIG. 4 shows an end sectional view taken along the line 4-4 of FIG. 2; and

FIG. 5 shows a sectional view like that of FIG. 3, only showing the side wall sections between the cavities as appearing to cross at their mid-sections.

### DETAILED DESCRIPTION

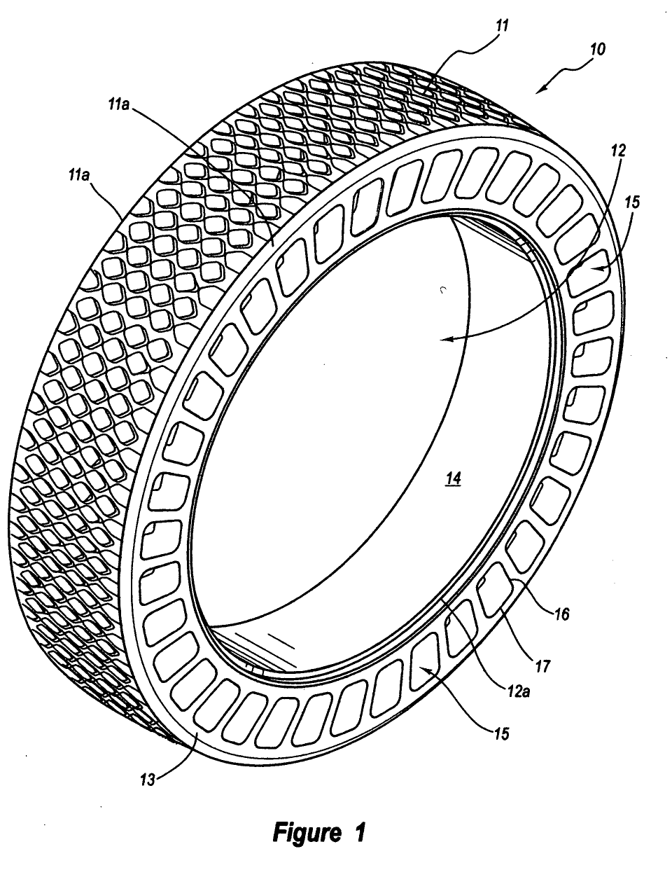

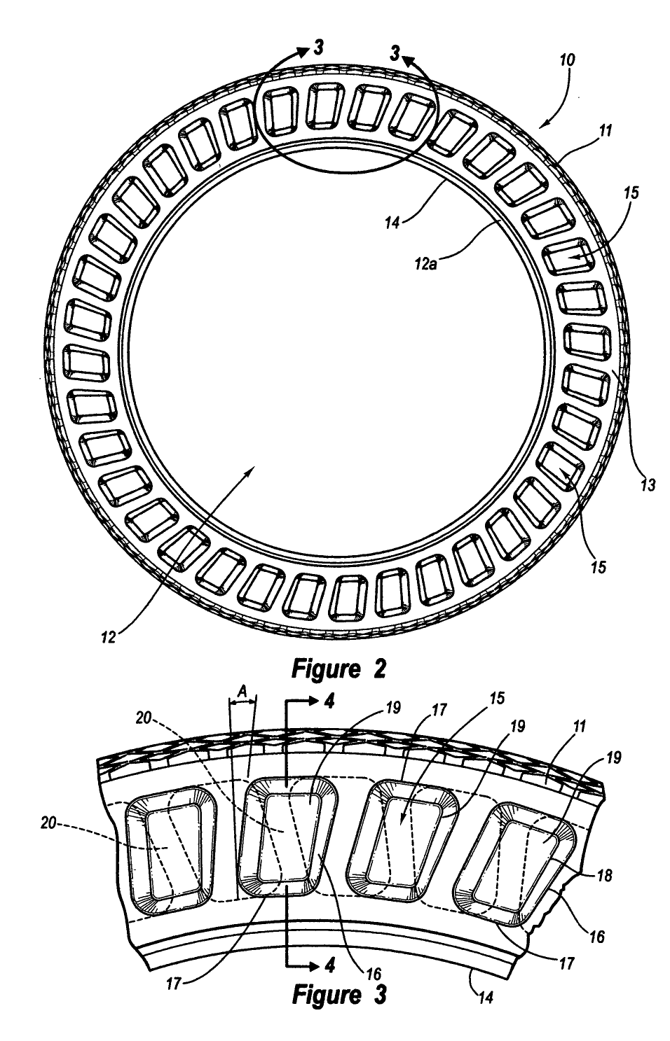

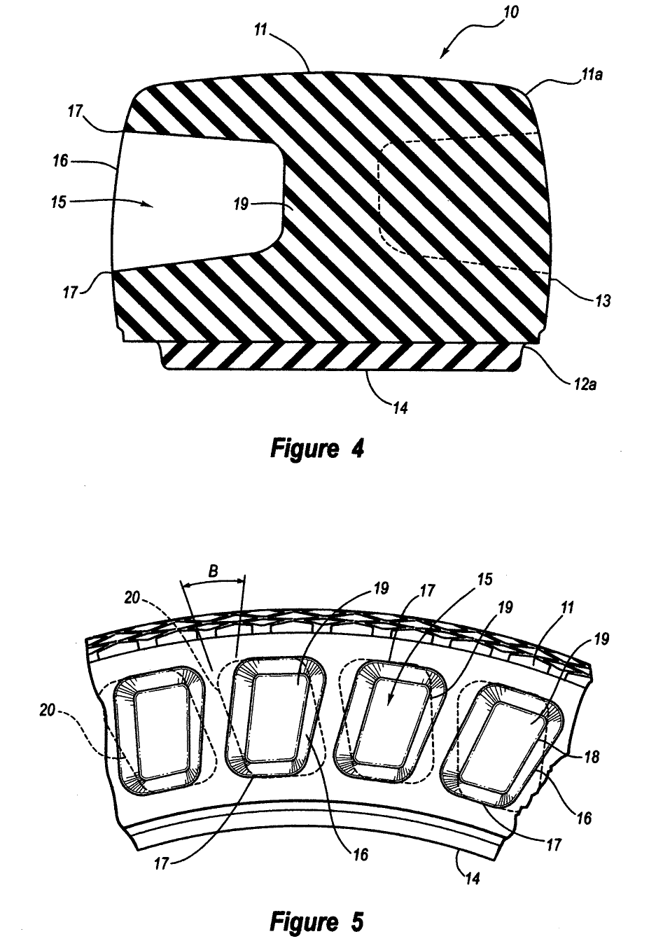

The invention is in an airless spare tire 10, as shown in FIG. 1, is formed with an outer tread 11 across its top surface, preferably having a traction enhancing surface, shown as a diamond pattern, though, it should be understood, any traction enhancing pattern could be employed, within the scope of this disclosure. The tire 10 is open at its center 12 to fit onto a wheel, not shown, and includes like side walls 13. The side walls 13 extend downwardly from both tread edges 11a, that are shown as being beveled, and terminate at wheel steps 12a. The steps 12a to step towards the tire center to a wheel rim mounting surface 14, that is flat thereacross. Unique to the invention, as shown best in FIG. 4, the tire side walls 13 include spaced cavities 15, formed into the side walls, that are at equal spaced intervals therearound, leaving a tire wall section 20 between adjacent cavities. The tire 10 is preferably formed by molding or casting methods from a mixture of urethane constituents such as a polyol with an Isocyanate to form a homogeneous finished polyurethane tire having a hardness of approximately seventy (70) to eighty five (85) Shur-A, to provide for tire flexure. The cavities 15 provide a tire of lesser weight then earlier solid tires, to both encourage tire flexure and provide an improved ride over earlier solid tires. Which cavities further allow heat, as is generated by tire rolling under load, to pass out from the tire, maintaining a lower tire internal temperature than has been possible with earlier solid tires, to maintain tire stability over distance travel and time.

The cavities 15, as shown in FIGS. 3 and 5, are formed as parallelograms, having long side walls 16 and shorter top and bottom end walls 17, with rounded corners 18. The long side walls 16 are parallel to one another and the top and bottom end walls 17 are parallel to one another, and extend to a tire center dividing wall 19, shown best in FIG. 4, separating the cavities 15. The cavities side walls and end walls are not at right angles to one another, and the angle between which cavity side walls and end walls is determined by the angle that the side walls forms with a line, that is a straight radial line projecting from the center of the tire open center, out to the tread 11. Which relationship of the radial line and the cavity side wall 16 is shown as angles A and B in FIGS. 3 and 5, respectively. Which angle A and B are selected to maintain the parallel top and bottom end walls 17 essentially parallel to the tire tread surface 11, at the tire tread edges and provide, as set out below, for a proper alignment of the tire side wall sections 20 across the tire center dividing wall 19. In practice, as set out below, the angles A and B are selected to where side wall sections 20, that are located between adjacent cavities 15, on opposite sides of the tire 10, will align to appear to cross one another, forming a V, as shown in FIG. 3 or an X as shown in FIG. 5, with in FIG. 3, for a tire having a diameter of twenty six (26) inches, angle A is approximately seven point five (7.5) degrees, to provide for alignment of the side wall sections 20 ends and, as shown in FIG. 5, for a same diameter of tire 10, angle B is approximately seven point five (7.5) degrees to provide for the opposing side wall sections 20 to align to appear to cross at approximately their mid point. Though the arrangement of FIGS. 3 and 5 is preferred, the invention can include other crossing intersections of the one wall section with the other opposite wall section 20 between its center and ends. In both of which preferred intersection of the opposing side wall sections 20 across the center dividing wall 19, as shown in FIGS. 3 and 5, the side wall sections 20 connected at opposite surfaces of the tire center wall 19, tend to function like a truss , supporting the tire tread and supporting and transferring loads thereacross compressive loads as are directed through the tire tread 11, that pass across the tire 10 and into the tire wheel steps 12a and rim mounting surface 14 that engages a wheel hub, not shown.

In practice, a tire 10 having opposing side wall sections 20, separated by the center dividing wall 19 having an X crossing as illustrated by angle B in FIG. 5, has been tested under a load of fifteen hundred (1500) pounds, at a speed of fifty (50) miles per hour for two thousand sixty (2060) minutes, and in high speed testing: for two (2) hours at fifty (50) miles per hour: for point five (0.5) hours at seventy five (75) miles per hour; for point five (0.5) hours at eighty (80) miles per hour; and for point five (0.5) hours at eighty five (85) miles per hour, with the tire 10, at the end of the testing, showing little or no wear or overheating.

The cavities 15, as set out above, are formed in the tire 10 opposite side walls 13 as parallelograms. The individual cavities can have straight side and top and bottom end walls 16 and 17, respectively, that form approximately ninety (90) degree angles with the center dividing wall 19, or the side walls can be sloped slightly outwardly from the cavity at its junction with the side wall 13 to its contact with the center dividing wall 19. Which slope is for convenience of manufacture, facilitating mold separation, and adds mass at the cavity and center dividing wall 19 junction to strengthen the tire against collapse should it experience side loads.

While preferred embodiments of our invention in an airless spare tire have been shown and described herein, it should be understood that variations and changes are possible to the described airless spare tire, and the materials used, without departing from the subject matter coming within the scope of the following claims, and a reasonable equivalency thereof, which claims we regard as our invention.

We claim:

1. An airless spare tire comprising, a tire formed from as a single unit from an elastomeric material having an essentially flat top tread surface, identical side walls and a bottom section to fit into a wheel rim; and which said side walls have like equal space cavities formed therein that each have a shape of a parallelogram and extend inwardly to a tire center section, and where said cavities in one side of said tire side wall are offset from said cavities of the other side wall side, separated by said tire center section, with short sided of said parallelogram cavities being essentially parallel to an edge of said flat top tread surface and a long side of each said parallelogram shaped cavity forms a selected angle to a radial across said tire side wall such that tire wall sections along side of said offset cavities align with a like offset tire wall section across said tire center section.

2. The airless spare tire as recited in claim 1, wherein the cavity offset tire wall sections separated by the tire center section align to appear to cross one another.

3. The airless spare tire as recited in claim 1, wherein the cavity ends of the tire wall sections separated by the tire center section appear to align to intersect one another.

4. The airless spare tire as recited in claim 3, wherein the aligned cavity ends of the tire side wall sections are adjacent to the tire bottom section.

5. The airless spare tire as recited in claim 1, wherein the angle formed by the parallelogram cavity long side a radial is an angle from five (5) to fifteen (15) degrees.

6. The airless spare tire as recited in claim 1, wherein the parallelogram shaped cavity inner corners are rounded.

7. The airless spare tire as recited in claim 1, wherein the tire is formed from a polyurethane material.

8. The airless spare tire as recited in claim 1, wherein the tire center section is essentially flat and slots that each have like essentially right angle sides are formed around said tire center section opposite ends.
